(19) United States
(12) Patent Application Publication
(10) Pub. No.: US 2026/0273854 A1
(43) Pub. Date: Sep. 17, 2026

(54) METHOD FOR CONTROLLING A MATERIAL FEED ELEMENT

(71) Applicant: Siemens Aktiengesellschaft, 80333 München (DE)

(72) Inventor: Jens Jähnicke, Chemnitz (DE)

(73) Assignee: Siemens Aktiengesellschaft, 80333 München (DE)

(21) Appl. No.: 19/167,640

(22) PCT Filed: Feb. 21, 2024
(86) PCT No.: PCT/EP2024/054353

§ 371 Date: Sep. 22, 2025

(30) Foreign Application Priority Data
Mar. 23, 2023 (EP) 23163775.2

(51) Int. Cl. B29C 64/321; B29C 64/118; B29C 64/209; B29C 64/245; B29C 64/386; B33Y 30/00; B33Y 40/00; B33Y 50/00; C03B 19/00; G05B 19/4155

(52) U.S. Cl. CPC B29C 64/321; B29C 64/118; B29C 64/209; B29C 64/245; B29C 64/386; B33Y 30/00; B33Y 40/00; B33Y 50/00; C03B 19/00; G05B 19/4155; G05B 2219/31376; G05B 2219/36019; G05B 2219/49023

(57) ABSTRACT

In a method for controlling a material feed element in additive manufacturing, material is moved in direction of a material-dispensing nozzle through pressure applied by the material feed element as the material feed element covers a distance. The distance for building up the pressure is determined by a desired material flow speed and by a previous actual material flow speed. The desired material flow speed is multiplied by a factor determined by a difference between the desired material flow speed and the previous actual material flow speed. When a material flow speed changes, a compensation value gained from a mathematical product of the desired material flow speed and the factor is pilot-controlled. The nozzle is moved at a track speed over a work table. The pressure is reduced before an imminent reduction in the track speed, and the pressure is increased before an imminent increase in the track speed.

The invention relates to a method for controlling a material feed.

EP 3172026 B1 shows an assembly for use in an additive manufacturing system for printing a three-dimensional part, which comprises an extruder with a gear wheel and a motor that rotates the gear wheel, wherein the rotation of the gear wheel regulates a flow of material from the extruder. A controller provides a control signal to the motor in order to control the speed at which the motor rotates the at least one gear wheel, and integrates a time-varying signal into the control signal in order to reduce the ripple of the material dispensed from the extruder.

US 2022/314550 A1 shows an apparatus for modeling a three-dimensional laminated object comprises a cylinder configured to store a molten resin, an ejection nozzle which is connected to the cylinder, and a piston configured to expel the molten resin from the ejector nozzle, by moving in one direction of approach to the ejection nozzle and pressurizing the molten resin in the cylinder, and modeling a three-dimensionally modeled object by laminating a resin sphere, which is the molten resin ejected from the ejector nozzle, on a table. It comprises a drive apparatus configured to move the ejection nozzle relative to the table and at least one processor configured to sense a speed of movement of the ejector nozzle and control the movement of the piston based on the speed of movement of the ejector nozzle,

In additive manufacturing methods, material extrusion can lead to errors in the material flow due to changes in speed on the track. In particular, interpolation provides the axes involved (especially track and material feed) with matching set values. However, there are non-linear relationships from the material feed to the exit of the material from a nozzle, which have so far only been insufficiently taken into account.

The object underlying the invention is to improve material extrusion in this respect.

The object is achieved by claim 1, Le. a method for controlling a material feed element in additive manufacturing of a layer or a body, wherein the body preferably has a plurality of layers, wherein material is moved in the direction of a nozzle dispensing the material by means of pressure from a material feed element, wherein the nozzle is moved at a track speed over a work table, wherein the pressure is applied by covering a distance through the material feed element, wherein the distance to be covered to build up the pressure is determined by a desired material flow speed and by a previous actual material flow speed.

The material flow speed is particularly important for a layer height and width.

The material flow speed preferably reveals how much material is dispensed per time unit or per unit path on the track through the nozzle.

A design in which the desired material flow speed is multiplied by a factor is advantageous.

The factor can advantageously be used to compensate for errors caused by real conditions, such as inertia of a material mass, non-linear behavior of pressurized materials, shearing forces and/or delayed melting of material.

The factor is advantageously based on empirical values and is advantageously stored in the controller.

The factor can have different values for different material flow speeds. This is shown in the description of the figures.

An embodiment according to which the factor is determined by a difference between the desired material flow speed and the previous actual material flow speed is advantageous.

This means, for example: if there is a high material flow speed and this is to be reduced to a different material flow speed, because e.g. the track speed of the nozzle is reduced, the pressure on the material must be decreased. However, since this pressure reduction usually does not take effect immediately, but only with a delay, a difference between the high previous material flow speed and the now desired material flow speed is used to determine the factor.

An embodiment in which the desired material flow speed correlates with the track speed of the nozzle is advantageous.

This is advantageous because it allows a layer thickness and/or width to be achieved that is at least essentially the same.

This is because, for example, when braking is applied or the track speed is reduced when cornering on the track, less material should also escape from the nozzle.

One embodiment, according to which the distance to be covered is additionally determined by a modulus of elasticity of the material, preferably at least partially melted, is advantageous.

The material may be completely or partially melted.

As explained later in the description of the figures, an advantageous apparatus for carrying out the method has a nozzle with a heating element. If there is a high material flow speed for a long time, the heating element may in some instances not be able to melt material to the same extent. This can also be compensated for by the described method, in particular on the basis of empirical values that can be stored in a program on a controller.

In other words, this advantageously means: with a high material feed, the melt reservoir in most cases becomes smaller. The resulting pressure depends on the history of the current size of the melt reservoir, which in turn depends on the speed.

One embodiment, according to which the pressure and the material flow speed interact in such a way that a layer height and/or a layer width of the material dispensed by the nozzle remains at least essentially the same during additive manufacturing, is advantageous.

In this way, bodies with several layers can be reliably formed.

The layer height and/or layer width are advantageously stored in the G-code for the purpose of modifying a material flow correction.

One embodiment, according to which the pressure is reduced before an imminent decrease in the track speed, is advantageous.

Due to the time delay already mentioned, a certain amount of time between the two steps is advantageous.

One embodiment, according to which the pressure is increased before an imminent Increase in the track speed, is advantageous.

Due to the time delay already mentioned, a certain amount of time between the two steps is advantageous.

The following can be advantageous: the factor for compensation depends on speed. Changes in cross-section are advantageously taken into account. A dynamic of the real material flow is advantageously taken into account.

The object is also achieved by means of an apparatus for carrying out the method.

Advantageously, such an apparatus has at least the following:
a work table embodied for depositing material,
a nozzle embodied to dispense material,
a material feed element embodied to move material in the direction of the nozzle dispensing the material,
a controller embodied for controlling the material feed element.

The controller is advantageously also embodied to control the track speed or generally to control a path of the nozzle.

Advantageously the nozzle has a heating element. This allows the material to be melted.

The object is also achieved by a computer program product, comprising commands that cause the apparatus to carry out the method steps.

The program is advantageously stored on the controller.

The object is achieved by a computer-readable medium on which the computer program product is stored.

The solution of the object is also achieved by means of a computer program product, comprising commands which, when a computer, in particular a controller, executes a program, cause it to execute the method.

The program is advantageously stored on the controller,

The invention is described and explained in more detail below on the basis of the exemplary embodiments shown in the figures. It is shown in:

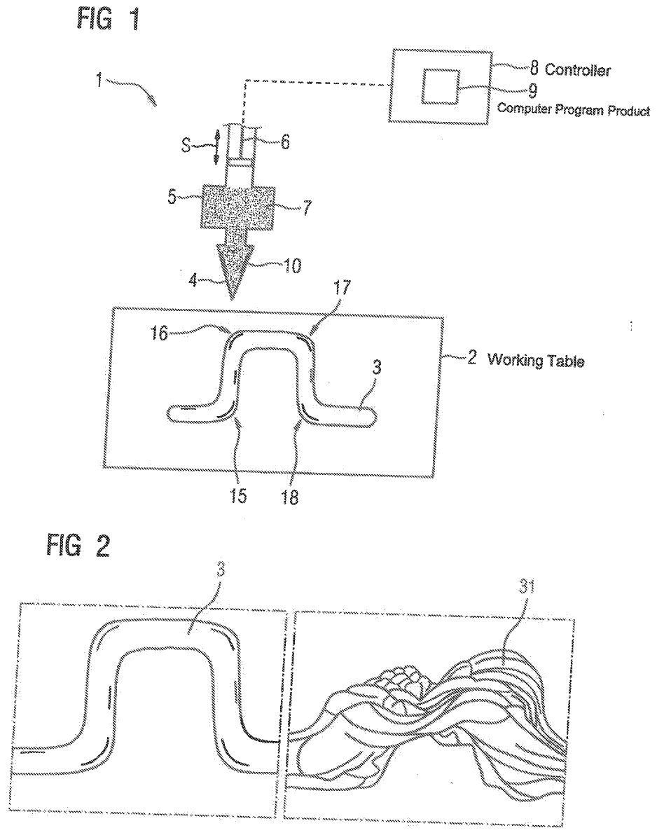

FIG. 1 an exemplary manufacturing apparatus for carrying out the method,

FIG. 2 a comparison of thickenings,

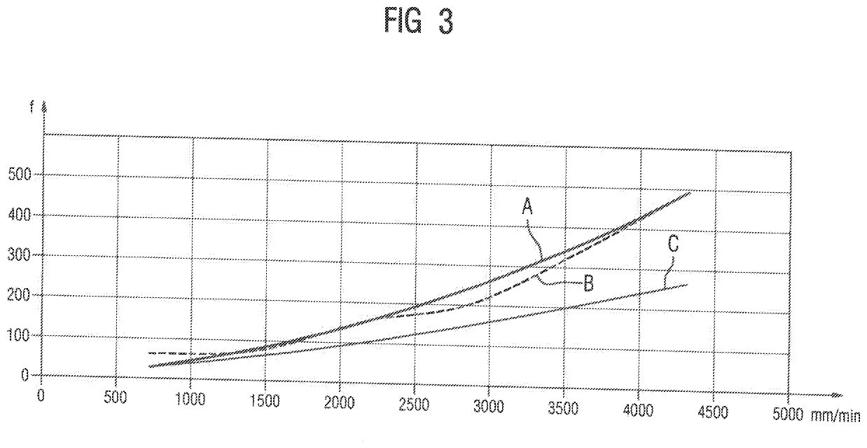

FIG. 3 exemplary compensation values,

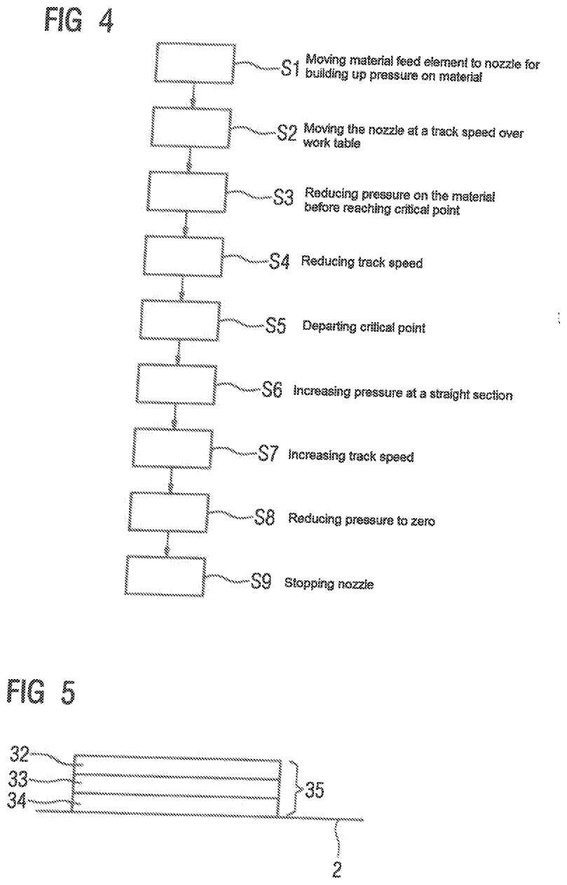

FIG. 4 an exemplary course of the method,

FIG. 5 a thickening with several layers or a body,

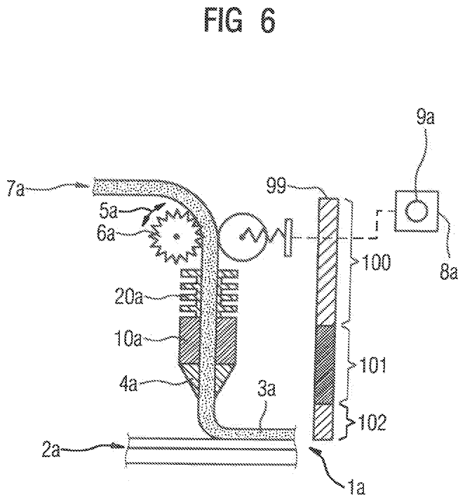

FIG. 6 another possible embodiment of the apparatus.

FIG. 1 shows an exemplary manufacturing apparatus 1 for carrying out the method.

The apparatus 1 comprises a working table 2, on which a thickening 3 is applied additively.

This is achieved by a nozzle 4 with a reservoir 5. By means of a material feed element 6, material 7, which is advantageously at least partially melted, is applied to form the thickening 3.

The material feed element 6 can be a plunger or also an extruder screw. Other forms are also possible, see also in FIG. 6.

The material feed element 6 advantageously exerts pressure on the material 7.

The pressure is applied by covering a distance S through the material feed element.

If there is a certain overpressure in the nozzle 4, it is advantageous that material 7 leaks out of the nozzle 4. The material 7 is advantageously melted by heating elements 10.

The material is preferably plastic. The material can also be glass, for example.

The material is advantageously a compressible material.

The method is particularly well suited to viscous materials, including adhesives or silicone, for example.

The figure also shows a controller 8 and a computer program product 9, which is present in the figure on the controller 8 and instructs the manufacturing apparatus 1.

FIG. 2 shows a comparison of thickenings 3 and 31.

On the left, a printed thickening 3 is shown by way of example, in which a material flow speed was lower than in the thickening 31 shown on the right.

In particular, in the area of the corners 15, 16, 17 and 18, a track speed with which the nozzle 4 moves over the working table 2 is reduced. However, a layer height and layer width of the thickening 3 should also be advantageously maintained at these points. To maintain the layer height and layer width of thickening 3, it is advantageous to apply less material when the track speed is reduced.

If less material is to be applied, a reduction in the material flow speed is advantageously achieved. The material flow speed and the track speed advantageously correlate. There is advantageously a linear relationship between the track speed and the material flow speed.

As already explained, the material feed element 6 advantageously exerts pressure on the material 7, which advantageously leads to material 7 exiting nozzle 4 (cf. FIG. 1). The material 7 then advantageously exits at a desired material flow rate, The nozzle 4 is moved at a track speed.

If the track speed is now reduced, the material flow speed is also advantageously reduced. This is advantageously achieved by reducing or removing the pressure acting on the material 7.

However, this change in pressure usually does not have an immediate effect on the material 7 exiting the nozzle 4, but in most cases only with a delay. This usually leads to the material flow speed not being reduced to the desired extent and too much material escaping. This means that the layer height and layer width of the thickening cannot be maintained. This is exemplified using the thickening 31.

The material feed element 6 advantageously generates a material movement or material flow in the form of a path. The material 7 is advantageously melted. Depending on the modulus of elasticity of the non-molten and molten material 7, this path advantageously leads to a change in pressure in the nozzle 4.

The material 7 is plastic, for Instance, wherein developing shearing forces are dependent on the pressure. The material flow usually does not depend linearly on the pressure.

Preferably, when a material flow speed changes, a suitable (preferably derived from empirical values), speed-dependent path is pre-controlled, a compensation path or a compensation value, so to speak.

This compensation value is preferably the mathematical product of the desired material flow speed and a factor, wherein the factor depends on a difference between the current desired material flow speed and a previous actual material flow speed.

The compensation value can be determined, for example, by determining a material volume error in the event of material flow changes and deducing the compensation value for the path from this.

Since the compensation value is advantageously dependent on the material flow speed, this is advantageously carried out for speed ranges in the preferably entire working field.

Since printing at the outlet of nozzle 4 is advantageous in the printing process in such a way that the desired layer height and layer width or a desired ratio of layer height to layer width is maintained, these values are advantageously stored in the controller (particularly suitable: G-code).

Previously determined compensation values can advantageously be taken into account in the process.

Since the compensation advantageously means that the material feed must make an additional movement to the movement from the interpolation, it is preferable to decouple the real material feed and the material feed axis taken into account in the interpolation.

For the axis involved in the interpolation, it is preferable to use a virtual axis that takes into account the dynamics of the real material flow.

The physically existing axis is preferably coupled to the virtual axis via interpolation set values and/or a path compensation value for a pressure change from a material feed change and/or a compensation value from a change in cross-section and/or other compensation values (e.g. screw position compensation values).

FIG. 3 shows exemplary compensation values.

The abscissa shows the material flow speed in mm/min. The ordinate shows a factor f. The figure also shows the curves A, B and C.

A shows variant 1, polynomial approximated to the measurements. B shows measured values for compensation. C shows variant 2, polynomial approximated to the measurement.

The factor advantageously results from empirical values or from previous experiments. The figure shows the measured speed-dependent correction factors in B and variants derived therefrom for correction in polynomial form in A and C.

FIG. 4 shows an exemplary course of the method.

In a method step S1, pressure is built up on the material by moving the material feed element in the direction of the nozzle and thus covering a distance.

In this way, the material is moved in the direction of the nozzle and/or advantageously compressed. The material advantageously exits the nozzle when a pressure in the nozzle that exceeds the pressure outside the nozzle is reached. Depending on the desired layer height and/or layer width, this pressure difference is advantageously adjusted. To put it simply, this means: the higher the difference between the pressure outside the nozzle and the pressure inside the nozzle, the higher and/or wider the printed layer will be (or the larger a cross-section of the layer).

In a method step S2, the nozzle is moved advantageously over the work table at a track speed on a track preferably present In a program on the controller.

By way of example, the track has a corner or bend 15, cf. FIG. 1. Before the nozzle reaches this critical point, the pressure on the material is reduced in a method step S3.

In this way, a reduction in the material speed is advantageously achieved.

In a method step S4, the track speed is reduced.

The reduction in the pressure and the reduction in the track speed advantageously work together in such a way that the height and width of the printed layer are maintained.

In a method step S5, the bend or corner 15 is departed.

In a method step S6, the pressure is increased as a straight section 18, cf. FIG. 1, follows the track. In a method step S7, the track speed is increased, advantageously so that the height and width of the printed layer are retained.

The method steps S3 to S6 can be repeated depending on the stored track.

In the end, the pressure is advantageously reduced to zero (see process step S8). In a method step S9, the nozzle is stopped.

FIG. 5 shows a thickening with several layers 32, 33, 34 or a body 35.

FIG. 6 shows a further possible embodiment of the apparatus, in the form of the apparatus 1a.

This has a work table 2a embodied to deposit material. In this embodiment the material is a filament 7a.

The apparatus 1a has a nozzle 4a, wherein the nozzle 4a is embodied for dispensing material. In the figure the apparatus has a material feed element 6a in the form of a feeder, embodied to move material, i.e. the filament 7a, in the direction of the nozzle 4a, and a controller 8a, embodied to control the material feed element 6a.

A thickening 3a is applied additively on the work table 2a.

This is achieved by a nozzle 4a. The filament 7a, which is advantageously at least partially melted, is applied to form the thickening 3a by means of the material feed element 6a.

The material feed element 6a advantageously exerts a pressure on the filament 7a.

The pressure is applied by covering a distance Sa through the material feed element 6a. In this embodiment, this is achieved by performing a rotation or twisting.

The material in the form of the filament 7a is advantageously melted by a heating element 10a and then advantageously exits from nozzle 4a.

The material is preferably plastic. The material can also be glass, for example.

The figure also shows an element for thermal decoupling 20a.

The figure also shows a controller 8a and a computer program product 9a, which is present in the figure on the controller 8a and instructs the manufacturing apparatus 1a.

The figure also gives an impression of the temperature 99 of filament 7a. In an area 100, filament 7a is still relatively cold and solid, for example.

The heating element 10a heats up the filament 7a. The filament is preferably viscous in an area 101.

If the filament rests on the work table 2a as thickening 3a after exiting the nozzle 4a, this is advantageously cooled down again in an area 102 and preferably solid.

1-12.(canceled)

13. A method for controlling a material feed element in additive manufacturing of a layer or a body, wherein the body preferably has a plurality of layers, the method comprising:
moving material in a direction of a material-dispensing nozzle through pressure applied by the material feed element as the material feed element covers a distance;
determining the distance to be covered for building up the pressure by a desired material flow speed and by a previous actual material flow speed;
multiplying the desired material flow speed by a factor;
determining the factor by a difference between the desired material flow speed and the previous actual material flow speed;
when a material flow speed changes, pilot-controlling a suitable compensation value gained from a mathematical product comprising the desired material flow speed and the factor;
moving the nozzle at a track speed over a work table;
reducing the pressure before an imminent reduction in the track speed, and increasing the pressure before an imminent increase in the track speed.

14. The method of claim 13, wherein the suitable compensation value is gained from empirical values and is speed-dependent.

15. The method of claim 13, further comprising correlating the desired material flow speed with the track speed of the nozzle.

16. The method of claim 13, further comprising additionally determining the distance to be covered by a modulus of elasticity of the material.

17. The method of claim 16, wherein the material is at least partially melted.

18. The method of claim 13, wherein the pressure and the material flow speed interact in such a way that a layer height and/or a layer width of the material dispensed by the nozzle remains at least essentially the same during additive manufacturing.

19. The method of claim 13, further comprising storing a layer height and/or layer width in G-code for modifying a material flow correction.

20. Apparatus for carrying out the method of claim 13, the apparatus, comprising:
a work table designed to deposit material;
a nozzle designed to dispense the material onto the work table;
a material feed element designed to move the material in a direction of the nozzle; and
a controller designed to control the material feed element.

21. A non-transitory computer program product, comprising commands which execute the method of claim 13 when the commands are executed on an apparatus for carrying out the method.

22. A computer-readable non-transitory medium on which the computer program product of claim 21 is stored.
